(19) United States
(12) Patent Application Publication
(10) Pub. No.: US 2006/0092302 A1
(43) Pub. Date: May 4, 2006

(54) Digital camera system with an image sensing device

(75) Inventor: Charng-Long Lee, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/152,054

(22) Filed: Jun. 15, 2005

(30) Foreign Application Priority Data
Nov. 3, 2004 (TW) 093133530

(51) Int. Cl. H04N 5/335

(52) U.S. Cl. 348/308

(57) ABSTRACT

A digital camera system with an image sensing device, wlhich includes an image sensing device, a converter, an image processor and a universal serial bus (USB) transceiver. The image sensing device receives light to capture an analog image signal. The converter is connected to the image sensing device to convert the analog image signal into a digital image. The image processor is connected to the converter to perform a special image processing on the digital image to thus produce a processed image. The USB transceiver is connected to the image processor to send the processed image to a host and receives digital camera parameters sent by the host.

### BACKGROUND OF THE INVENTION

1. Field of the Invention

The invention relates to a CMOS digital camera system and, more particularly, to a digital camera system with an image sensing device.

2. Description of Related Art

In general, a typical digital camera can be the type of charge coupled device (CCD) and complementary metal oxide semiconductor (CMOS) according to its internal image sensing device. Since a CMOS image sensing device has the pixel structure more complicated than a CCD but its light sensing opening is smaller than that of the CCD, when comparing CCD image sensing device with the CMOS one of the the same size, the CCD image sensing device has a resolution higher than the CMOS image sensing device. Accordingly, the CMOS image sensing device is widely used in low-class products.

FIG. 1 is a block diagram of a typical CMOS digital camera 100, which consists of a CMOS image sensing device 110, a sensing device interface 120, an image data compressor 130, a serial interface 150, a controller 160 and a USB interface 140. As shown in FIG. 1, the CMOS image sensing device 110 receives light to capture an image signal. The sensing device interface 120 receives an image sent by the CMOS image sensing device 110. The image data compressor 130 compresses an original image received and sends the compressed image to a host (not shown) through the USB interface 140.

After the compressed image sent by the USB interface 140 is received, the host decompresses it and performs associated processing for displaying the image on the screen. If the CMOS image sensing device 110 has a higher resolution, the host needs more processing time and higher computational capability for rapidly displaying an image on the screen. However, this increases the load of the host and influences the display speed of the CMOS digital camera on the host. Therefore, it is desirable to provide an improved CMOS digital camera to mitigate and/or obviate the aforementioned problems.

### SUMMARY OF THE INVENTION

The object of the invention is to provide a digital camera system with an image sensing device, which can perform image processing to thus reduce the processing time and computational capability of a host and rapidly display an image on the screen.

According to a feature of the invention, a digital camera system with an image sensing device is provided. The system includes an image sensing device, a converter, an image processor and a universal serial bus (USB) transceiver. The image sensing device receives light to capture an analog image signal. The converter is connected to the image sensing device to convert the analog image signal into a digital image. The image processor is connected to the converter to perform a special image processing on the digital image to thus produce a processed image. The USB transceiver is connected to the image processor to send the processed image to a host and receives digital camera parameters sent by the host.

According to another feature of the invention, a digital camera system with an image sensing device is provided. The system includes an image sensing device, a converter, an image processor, an RGB to YUV converter and a universal serial bus (USB) transceiver. The image sensing device receives light to capture an analog image signal. The converter is connected to the image sensing device to convert the analog image signal into a digital image. The image processor is connected to the converter to perform an image processing on the digital image to thus produce a processed image. The RGB to YUV converter is connected to the image processor to convert the processed image from an RGB to a YUV mode to thus produce a YUV image. The USB transceiver is connected to the RGB to YUV converter to send the YUV image to a host and receives digital camera parameters sent by the host.

According to a further feature of the invention, a digital camera system with an image sensing device is provided. The system includes an image sensing device, a converter, an image processor, an RGB to YUV converter, a universal serial bus (USB) transceiver and a sound encoder. The image sensing device receives light to capture an analog image signal. The converter is connected to the image sensing device to convert the analog image signal into a digital image. The image processor is connected to the converter to perform an image processing on the digital image to thus produce a processed image. The RGB to YUV converter is connected to the image processor to convert the processed image from an RGB to a YUV mode to thus produce a YUV image. The USB transceiver is connected to the RGB to YUV converter to send the YUV image to a host and receives digital camera parameters sent by the host. The sound encoder is connected to the USB transceiver to code an analog audio signal and to send the audio signal coded to the host through the USB transceiver.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical CMOS digital camera;

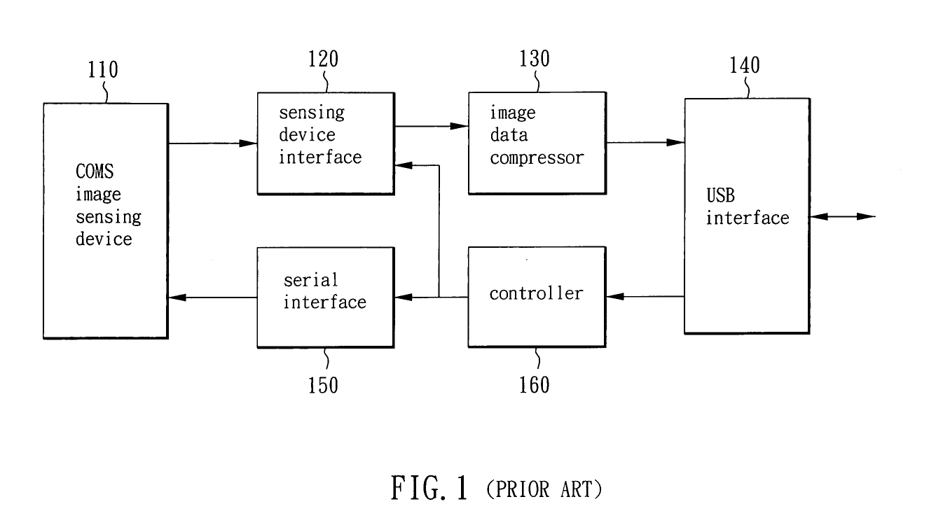

FIG. 2 is a block diagram of a digital camera system with an image sensing device according to the invention;

FIG. 3 is a schematic view of sensing pixels of a CMOS image sensing device according to the invention;

FIG. 4 is a block diagram of an embodiment according to the invention; and

FIG. 5 is a block diagram of another embodiment according to the invention.

### DETAILED DESCRIPTION OF THE PREFERRED EMBODIMENT

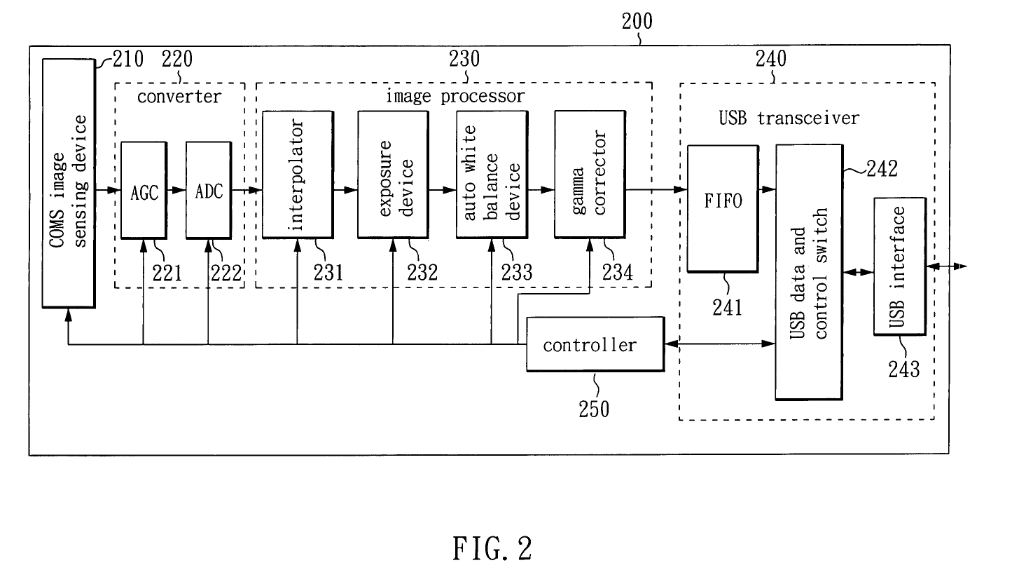

FIG. 2 is a block diagram of a digital camera system with an image sensing device according to the invention. In FIG. 2, the system includes an image sensing device 210, a converter 220, an image processor 230, a universal serial bus (USB) transceiver 240 and a controller 250. The image sensing device 210 is a complementary metal oxide semiconductor (CMOS) image sensing device to receive light to thus capture an analog image signal. The converter 220 is connected to the image sensing device 210 to convert the analog image signal into a digital image.

The image processor 230 is connected to the converter 220 to perform an image processing on the digital image to thus produce a processed image. The USB transceiver 240 is connected to the image processor 230 to send the processed image to a host (not shown) and to receive digital camera parameters sent by the host. The controller 250 is connected to the USB transceiver 240 to set the image sensing device 210 and the image processor 230 according to the parameters sent by the host or default digital camera settings stored in the controller.

The converter 220 includes an automatic gain controller (AGC) 221 and an analog-to-digital converter (ADC) 222. The AGC 220 is connected to the image sensing device 210 to adjust a gain of the AGC 221 according to a control signal produced by the controller 250 and to further adjust an analog image signal output by the image sensing device 210 such that the analog image signal adjusted meets with an input range of the ADC 222, thereby obtaining an optimal image signal. The ADC 222 is connected to the AGC 221 to convert the analog image signal adjusted into a digital signal, thereby obtaining a digital image.

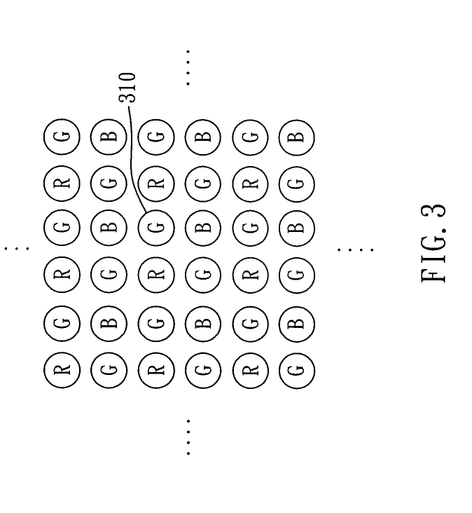

The image processor 230 includes an interpolator 231, an exposure device 232, an automatic white balance device 233 and a gamma corrector 234. The interpolator 230 is connected to the ADC 222 to interpolate the digital image. As shown in FIG. 3, pixel 310 only has green color, and thus the interpolator 231 is employed to produce red and blue colors using pixels around the pixel 310, such that the pixel 310 can have the three primary colors of green, read and blue, and performs the same processing on the remaining pixels. Thus, an image sensed by the CMOS image sensing device 210 is interpolated by the interpolator 231 to thus obtain an image with each pixel containing red, green, and blue colors (briefly, an interpolated digital image).

The exposure device 232 is connected to the interpolator 230 to perform an exposure correction on the interpolated digital image. The exposure correction determines the environment of a current photographer by an exposure metering to thus find optimal exposure parameters. When a light hits the CMOS image sensing device 210 through a lens to thus produce charges. The converter 220 converts an analog signal into a digital signal. The exposure device 232 measures the exposure intensity over the entire or partial frame to obtain a measured value. The controller 250 adjusts the exposure parameters based on the measured value and further adjusts the gain of the AGC 221 to thus obtain a best exposure amount.

The white balance device 233 is connected to the exposure device 232 to perform a white balance correction on the digital image after the exposure. The gamma corrector 234 is connected to the automatic white balance device 233 to perform a gamma correction on the digital image after the white balance correction. The gamma correction is performed to compensate a non-linearity feature of the CMOS image sensing device 210, which is caused by a non-linearity relation between an input light amount of the sensing components (pixels) of the CMOS image sensing device 210 and its corresponding output voltage.

The USB transceiver 240 includes a first-in first-out (FIFO) buffer 241, a USB data and control switch 242 and a USB interface 243. The FIFO buffer 241 is connected to the image processor 230 to temporarily store the image data output by the image processor 230. In this case, the FIFO buffer 241 is a single-port FIFO buffer.

The USB data and control switch 242 has one terminal connected to the FIFO buffer 241 to receive output data by the FIFO buffer 241 and the other terminal connected to the controller 250 to transmit the parameters to the controller 250. The USB interface 243 is connected to the USB data and control switch 242 to receive and transmit data to the host.

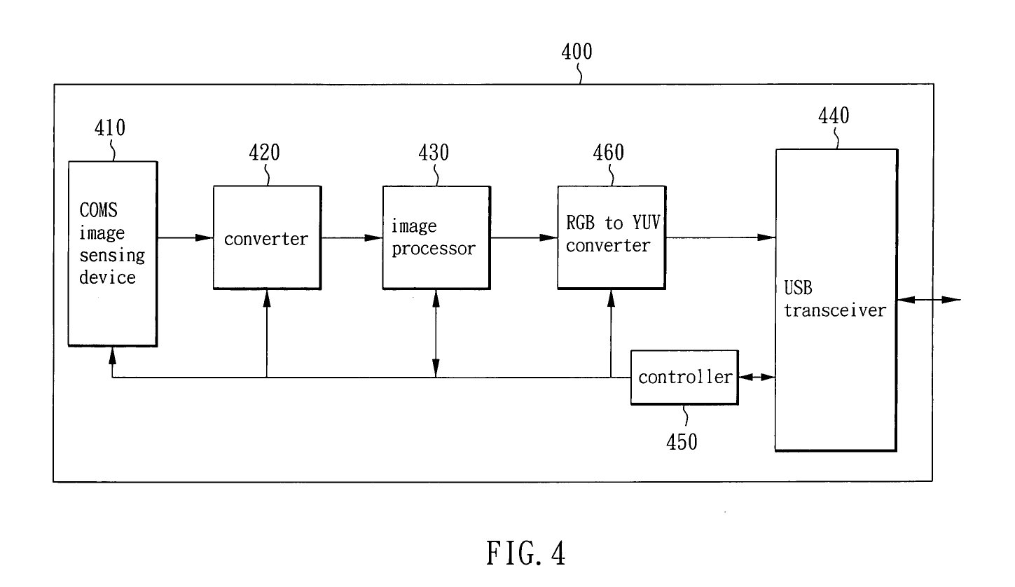

FIG. 4 is a block diagram of an embodiment according to the invention. This embodiment is similar to that shown in FIG. 2, except that an RGB to YUV converter 460 is provided between the image processor 430 and the USB transceiver 440. The RGB to YUV converter 460 is connected to the image processor 430 to convert the processed image from an RGB to a YUV mode to thus produce a YUV image and send it to a host (not shown) for further processing through the USB transceiver 440. As such, the host can directly compress the YUV image to obtain a compressed YUV image, i.e., a typical JPEG image and save the RGB to YUV conversion.

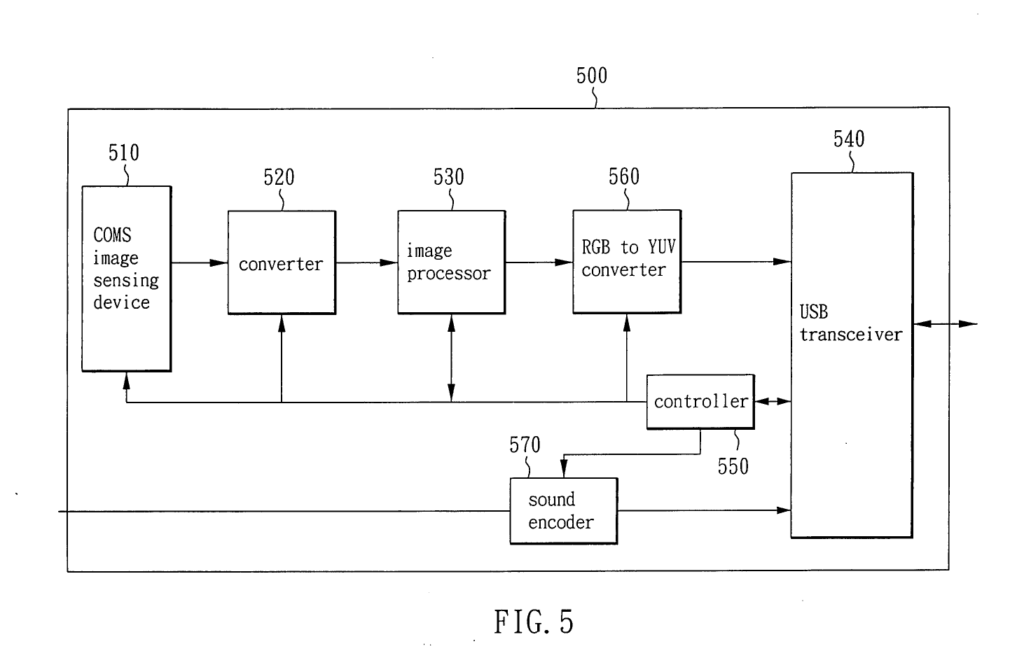

FIG. 5 is a block diagram of another embodiment according to the invention. This embodiment is similar to that shown in FIG. 4, except that a sound encoder 570 is provided. The sound encoder 570 is connected to the USB transceiver 440 to receive an analog audio signal produced by a microphone (not shown) for coding and to send the audio signal coded to the host through the USB transceiver 540.

As cited, since the transmission speed of the USB interface is getting higher and higher, there is almost no influence on the transmission bandwidth of the USB interface for an image data amount with compression or not. Accordingly, a host load is relatively reduced when receiving an image that does not require being decompressed and performed with operations such as interpolation, exposure correction, automatic white balance correction and gamma correction. In addition, since the operations are performed in the CMOS digital camera, the gain of the AGC can be adjusted by referring to the results performed and the parameters set by the host. Thus, the analog image signal adjusted can meet with the input range of the ADC, and accordingly an optimal image signal is obtained.

Although the present invention has been explained in relation to its preferred embodiment, it is to be understood that many other possible modifications and variations can be made without departing from the spirit and scope of the invention as hereinafter claimed.

What is claimed is:

1. A digital camera system with an image sensing device, comprising:
an image sensing device, which receives light to capture an analog image signal;
a converter, which is connected to the image sensing device to convert the analog image signal into a digital image;
an image processor, which is connected to the converter to perform an image processing on the digital image to thus produce a processed image; and
a universal serial bus (USB) transceiver, which is connected to the image processor to send the processed image to a host and receives digital camera parameters sent by the host.

2. The system as claimed in claim 1, further comprising:
a controller, which is connected to the USB transceiver to set the image sensing device and the image processor according to the digital camera parameters sent by the host or default digital camera parameters stored in the controller.

3. The system as claimed in claim 1, wherein the image sensing device is a complementary metal oxide semiconductor (CMOS) image sensing device.

4. The system as claimed in claim 1, wherein the converter comprises:
an automatic gain controller (AGC), which is connected to the image sensing device to adjust the analog image signal; and
an analog to digital converter (ADC), which is connected to the AGC to convert the analog image signal adjusted into a digital signal to thus obtain the digital image.

5. The system as claimed in claim 4, wherein the image processor comprises:
an interpolator, which is connected to the ADC to perform an interpolation on the digital image to thus produce an interpolated digital image;
an exposure device, which is connected to the interpolator to perform an exposure correction on the interpolated digital image to thus produce an exposed digital image;
an automatic white balance device, which is connected to the exposure device to perform a white balance correction on the exposed digital image to thus produce a white balance digital image; and
a gamma corrector, which is connected to the automatic white balance device to perform a gamma correction on the white balance digital image.

6. The system as claimed in claim 2, wherein the USB transceiver comprises:
a first-in first-out (FIFO) buffer, which is connected to the image processor to temporarily store image data output by the image processor;
a USB data and control switch, which has one terminal connected to the FIFO buffer to receive data output by the FIFO buffer and the other terminal connected to the controller to transmit the parameters to the controller; and
a USB interface, which is connected to the USB data and control switch to receive and transmit data to the host.

7. A digital camera system with an image sensing device, comprising:
an image sensing device, which receives light to capture an analog image signal;
a converter, which is connected to the image sensing device to convert the analog image signal into a digital image;
an image processor, which is connected to the converter to perform an image processing on the digital image to thus produce a processed image;
an RGB to YUV converter, which is connected to the image processor to convert the processed image from an RGB to a YUV mode to thus produce a YUV image; and
a USB transceiver, which is connected to the RGB to YUV converter to send the YUV image to a host and receives digital camera parameters sent by the host.

8. The system as claimed in claim 7, further comprising:
a controller, which is connected to the USB transceiver to set the image sensing device and the image processor according to the digital camera parameters sent by the host or default digital camera parameters stored in the controller.

9. The system as claimed in claim 7, wherein the image sensing device is a complementary metal oxide semiconductor (CMOS) image sensing device.

10. The system as claimed in claim 7, wherein the converter comprises:
an automatic gain controller (AGC), which is connected to the image sensing device to adjust the analog image signal; and
an analog to digital converter (ADC), which is connected to the AGC to convert the analog image signal adjusted into a digital signal to thus obtain the digital image.

11. The system as claimed in claim 10, wherein the image processor comprises:
an interpolator, which is connected to the ADC to perform an interpolation on the digital image to thus produce an interpolated digital image;
an exposure device, which is connected to the interpolator to perform an exposure correction on the interpolated digital image to thus produce an exposed digital image;
an automatic white balance device, which is connected to the exposure device to perform a white balance correction on the exposed digital image to thus produce a white balance digital image; and
a gamma corrector, which is connected to the automatic white balance device to perform a gamma correction on the white balance digital image.

12. The system as claimed in claim 8, wherein the USB transceiver comprises:
a first-in first-out (FIFO) buffer, which is connected to the image processor to temporarily store image data output by the image processor;
a USB data and control switch, which has one terminal connected to the FIFO buffer to receive data output by the FIFO buffer and the other terminal connected to the controller to transmit the parameters to the controller; and
a USB interface, which is connected to the USB data and control switch to receive and transmit data to the host.

13. A digital camera system with an image sensing device, comprising:
an image sensing device, which receives light to capture an analog image signal;
a converter, which is connected to the image sensing device to convert the analog image signal into a digital image;
an image processor, which is connected to the converter to perform an image processing on the digital image to thus produce a processed image;
an RGB to YUV converter, which is connected to the image processor to convert the processed image from an RGB to a YUV mode to thus produce a YUV image;
a USB transceiver, which is connected to the RGB to YUV converter to send the YUV image to a host and receives digital camera parameters sent by the host; and
a sound encoder, which is coupled to the USB transceiver to code an analog audio signal and to send the audio signal coded to the host through the USB transceiver.

14. The system as claimed in claim 13, further comprising:
a controller, which is connected to the USB transceiver to set the image sensing device and the image processor according to the digital camera parameters sent by the host or default digital camera parameters stored in the controller.

15. The system as claimed in claim 13, wherein the image sensing device is a complementary metal oxide semiconductor (CMOS) image sensing device.

16. The system as claimed in claim 13, wherein the converter comprises:
an automatic gain controller (AGC), which is connected to the image sensing device to adjust the analog image signal; and
an analog to digital converter (ADC), which is connected to the AGC to convert the analog image signal adjusted into a digital signal to thus obtain the digital image.

17. The system as claimed in claim 16, wherein the image processor comprises:
an interpolator, which is connected to the ADC to perform an interpolation on the digital image to thus produce an interpolated digital image;
an exposure device, which is connected to the interpolator to perform an exposure correction on the interpolated digital image to thus produce an exposed digital image;
an automatic white balance device, which is connected to the exposure device to perform a white balance correction on the exposed digital image to thus produce a white balance digital image; and
a gamma corrector, which is connected to the automatic white balance device to perform a Gamma correction on the white balance digital image.

18. The system as claimed in claim 13, wherein the USB transceiver comprises:
a first-in first-out (FIFO) buffer, which is connected to the image processor to temporarily store image data output by the image processor;
a USB data and control switch, which has one terminal connected to the FIFO buffer to receive data output by the FIFO buffer and the other terminal connected to the controller to transmit the parameters to the controller; and
a USB interface, which is connected to the USB data and control switch to receive and transmit data to the host.
